(19) United States
(12) Patent Application Publication
(10) Pub. No.: US 2016/0046775 A1
(43) Pub. Date: Feb. 18, 2016

(54) HEAT CURABLE ADHESIVE FILM

(71) Applicant: H.B. FULLER COMPANY, ST. PAUL, MN (US)

(72) Inventors: FELIX D. MAI, LUDWIGSHAFEN (DE); MUTOMBO J. MUVUNDAMINA, JOHNSON CITY, TN (US); BRIAN W. CARLSON, WOODBURY, MN (US); RITUPARNA PAUL, ST. PAUL, MN (US)

(21) Appl. No.: 14/824,798

(22) Filed: Aug. 12, 2015

Related U.S. Application Data
(60) Provisional application No. 62/036,368, filed on Aug. 12, 2014.

(51) Int. Cl. C08J 5/18; B32B 37/14; B32B 37/10; B32B 37/06; B32B 37/12

(52) U.S. Cl. CPC C08J 5/18; B32B 37/06; B32B 37/12; B32B 37/10; B32B 37/14; B32B 2305/72; B32B 2309/02; C08J 2375/08; C08J 2475/08; C08J 2333/08; C08J 2333/20; C08J 2433/08; C08J 2433/20

(57) ABSTRACT

Disclosed is a one layer adhesive film including a heat curable adhesive and a second adhesive composition. The heat curable adhesive includes a surface-deactivated solid isocyanate and a polymer that includes functional groups that are reactive with isocyanate. A method of making an article that includes the adhesive film and article made thereby are also disclosed.

### BACKGROUND OF THE INVENTION

The invention relates to an adhesive film that is one layer, including at least two different adhesives where one adhesive is partially embedded within the other adhesive.

### SUMMARY OF THE INVENTION

In one aspect, the invention features an adhesive film including: a first heat curable adhesive composition; and a second adhesive composition different from the first, the adhesive film being one layer, and one of the first or second adhesive compositions being partially embedded within the other; the first heat curable adhesive including: a surface-deactivated solid isocyanate; and a polymer reactive with isocyanate functionality. In one embodiment, the partially embedded adhesive composition is present in discrete domains. In another embodiment, the discrete domains are in the form of dots.

In one embodiment, the polymer reactive with isocyanate functionality is a polyurethane. In another embodiment, the first heat curable adhesive comprises at least about 60% by weight of a polyurethane, based on the weight of the heat curable adhesive. In a different embodiment, the polyurethane has a weight average molecular weight of no greater than about 100,000 g/mole and an enthalpy of fusion of at least about 25 J/g. In another embodiment, the heat curable adhesive is derived from an aqueous composition comprising a surface-deactivated solid isocyanate derived from an aromatic isocyanate, an aliphatic isocyanate, or a combination thereof, and a polyurethane having an enthalpy of fusion of at least about 25 J/g. In another embodiment, the polyurethane is derived from a crystalline polyester polyol and an isocyanate. In still another embodiment, the composition further comprises a second polymer.

In one embodiment, the second adhesive composition is a tacky adhesive composition. In one embodiment, the tacky adhesive composition comprises polyurethane, polyacrylate, or a combination thereof. In still another embodiment, second adhesive composition is a second heat curable adhesive composition.

In one embodiment, the adhesive film is supplied on release liner. In another embodiment, the adhesive film has a thickness of from about 10 microns to about 200 microns.

In another aspect, the invention features an adhesive film made by a process comprising the following steps: coating a second adhesive composition in discrete domains onto a release liner, and; coating a first heat curable adhesive directly over the second adhesive composition to form an adhesive film that is one layer; the second adhesive composition and the first heat curable adhesive composition being different from each other and the first heat curable adhesive composition comprising a surface-deactivated solid isocyanate and a polymer reactive with isocyanate functionality.

In one embodiment, the polymer reactive with isocyanate functionality is a polyurethane. In another embodiment, the second adhesive composition is a tacky adhesive composition. In one embodiment, the second adhesive is exposed on one major surface of the adhesive film. In a different embodiment, the second adhesive is exposed on both major surfaces of the adhesive film.

In another aspect, the invention features a method of making an article having a first substrate and a second substrate, the method comprising: contacting the first substrate with the tacky adhesive composition of the adhesive film; heating the adhesive film to a first temperature sufficient to render the first heat curable adhesive of the adhesive film tacky; and contacting a second substrate with the first heat curable adhesive of the adhesive film. In another embodiment, the method additionally includes heating the article to a second temperature so as to cure the first heat curable adhesive. In one embodiment, the first temperature is at least about 30° C. In another embodiment, one of the first substrate and the second substrate is rigid and the other of the first substrate and the second substrate is flexible.

In yet another aspect, the invention features a method of making an article having a first substrate and a second substrate, the method comprising: contacting the first substrate with the tacky adhesive composition of the adhesive film; contacting a second substrate with the first heat curable adhesive of the adhesive film; and applying pressure and heat to the assembly to form a permanent adhesive bond between the substrates.

Since the adhesive film is one layer it can form a bond with less pressure as opposed to a multi-layer adhesive film where one adhesive is deposited in discrete domains on top of the other adhesive.

### Glossary

The term “self-supporting adhesive film” means an adhesive film that maintains its integrity in the absence of any substrate.

The term “aqueous dispersion” means an aqueous dispersion, aqueous emulsion, aqueous suspension, or aqueous solution.

The term “permanent adhesive bond” means an adhesive bond that either cannot be altered or exhibits damage to either the adhesive or a substrate bonded to the adhesive when an attempt is made to alter the bond.

Other features and advantages will be apparent from the following description of the drawings, the preferred embodiments, and from the claims

### BRIEF DESCRIPTION OF DRAWINGS

FIG. 1 is a side view of a adhesive film with the partially embedded adhesive only exposed on one major surface of the film.

FIG. 2 is a side view of a adhesive film with the partially embedded adhesive exposed on both major surfaces of the film.

FIG. 3 is a top view of the first major surface of a adhesive film with the partially embedded adhesive

### DETAILED DESCRIPTION

### Adhesive Film

The adhesive film includes at least two adhesives. One of the adhesives, is a first heat curable adhesive. The other adhesive is the second adhesive.

One of the adhesives is partially embedded within the other, primary adhesive. The second adhesive can be the partially embedded adhesive and the first heat curable adhesive can be the primary adhesive. Alternately, the first heat curable adhesive can be the partially embedded adhesive and the second adhesive the primary adhesive.

The partially embedded adhesive composition is not present as a separate layer, rather it is partially surrounded by the primary adhesive.

The partially embedded adhesive is exposed on at least one major surface of the adhesive film. Alternately, the partially embedded adhesive is exposed on both major surfaces of the adhesive film.

The partially embedded adhesive can be present in discrete domains including e.g. random, splatter, dots, stripes (e.g. parallel lines), spirals, dashes, irregular shapes, islands, frames and combinations thereof.

The second adhesive composition can be a tacky adhesive composition. Alternately, the second adhesive composition can be a second heat curable adhesive with different properties from the first. Alternately, the second adhesive composition can be any adhesive different from the first heat curable adhesive.

The adhesive film can include a layer comprising an adhesive composite including a first major surface, a first heat curable adhesive, discrete domains of a second adhesive composition disposed in the first heat curable adhesive composition such that the first heat curable adhesive composition partially surrounds the discrete domains and at least a portion of the discrete domains are exposed at the first major surface.

The adhesive film can include a layer comprising an adhesive composite including a first major surface, a second adhesive, discrete domains of a first heat curable adhesive composition disposed in the second adhesive composition such that the second adhesive composition partially surrounds the discrete domains and at least a portion of the discrete domains are exposed at the first major surface.

The adhesive film can be supplied on release liner or alternatively can be supplied as a self-supporting adhesive film.

In one embodiment, the second adhesive composition is a tacky adhesive composition and is embedded within the first heat curable adhesive. The tacky adhesive can be used to maintain first substrate in a fixed position. Alternately, if the tacky adhesive is exposed on both major surfaces of the film it can be used to maintain two substrates in a fixed position. Preferably the tacky adhesive of the adhesive film can be used to form a tacky adhesive bond to a first substrate. The heat curable adhesive, when heated, can be used to form a bond to a second substrate. The bonds formed by the adhesive film can be uncured or cured.

The adhesive film can be heated to a temperature e.g., at least 60° C., or at least 70° C., or from about 60° C. to about 180° C., or from about 70° C. to about 120° C., or from about 70° C. to about 110° C., or in some embodiments, from about 80° C. to about 110° C. to activate the cure of the heat curable adhesive film, and form a cured bond with the second substrate.

Alternatively, the adhesive film can be subsequently heated to a first temperature (i.e., a temperature greater than room temperature) such that the heat curable adhesive film exhibits tack, and then, subsequently heated to a second temperature to activate the cure of the heat curable adhesive film.

The first temperature is at least 30° C., at least 40° C., from about 30° C. to about 60° C., or from about 40° C. to about 50° C.

The second temperature is higher than the first temperature and is sufficient to activate the cure of the heat curable adhesive film. The second temperature preferably is at least 20° C. greater than the first temperature. The second temperature is from about 60° C. to about 180° C., or from about 70° C. to about 120° C., or in some embodiments, from about 80° C. to about 110° C.

The adhesive film is storage stable and remains heat curable when stored at room temperature (i.e., from about 22° C. to about 25° C.).

The adhesive film can have any suitable thickness including, e.g., at least 10 microns (μm), at least 25 μm, at least 50 μm, from about 25 μm to about 200 μm, or from about 25 μm to about 150 μm.

### First Heat Curable Adhesive

The adhesive film includes a first heat curable adhesive. The first heat curable adhesive includes a surface-deactivated solid polyisocyanate, and a polymer that includes functional groups that are capable of reacting with isocyanate groups (which is also referred to herein as “polymer reactive with isocyanate functionality”).

The first heat curable adhesive is derived from an aqueous composition that includes a polymer that includes functional groups that are capable of reacting with isocyanate groups and a surface-deactivated solid polyisocyanate. The polymer and the surface-deactivated solid polyisocyanate can be supplied separately as a two part system, and then blended prior to the formation of the film. Alternately, the polymer and the surface-deactivated solid polyisocyanate can be supplied as a one part system that includes a blend of the polymer and the surface-deactivated solid isocyanate.

Polymer Reactive with Isocyanate Functionality

The first heat curable adhesive includes at least 30% by weight, at least 50% by weight, at least 70% by weight, at least 80% by weight, from about 30% by weight to about 97% by weight, from about 50% by weight to about 95% by weight, from about 70% by weight to about 95% by weight, or from about 80% by weight to about 95% by weight polymer reactive with isocyanate functionality, based on the weight of the dried heat curable adhesive.

The polymer is film-forming and can be a single type of polymer or a blend of at least two different polymers. The polymer includes functional groups that are capable of reacting with isocyanate functional groups. Useful functional groups include e.g., hydroxyl, amine, carboxyl, amide, epoxide, and mercaptan, and combinations thereof.

The polymer can be a polyurethane. The polyurethane preferably has a degree of crystallinity and a peak melting temperature that is sufficiently high to allow transportation and storage of the heat curable adhesive film and also sufficiently low to allow heat activation and crosslinking of the heat curable adhesive film. One useful measure of crystallinity is enthalpy of fusion. The enthalpy of fusion and the peak melting temperature of a polyurethane is measured using a dried film of the polyurethane. Useful polyurethanes, when in the form of a dried film, exhibit an enthalpy of fusion of at least 15 Joules per gram (J/g), at least 25 J/g, from about 15 J/g to about 70 J/g, from about 25 J/g to about 70 J/g, or from about 35 J/g to about 70 J/g. Useful polyurethanes, when in the form of a dried film form, also preferably exhibit a peak melting temperature of at least 30° C., at least 40° C., from about 30° C. to about 80° C., or from about 40° C. to about 60° C.

The polyurethane can have a relatively low molecular weight (Mw). Preferably the polyurethane has a weight average molecular weight of no greater than 120,000 gram/mole (g/mole), no greater than 100,000 g/mole, no greater than 90,000 g/mole, or no greater than 80,000 g/mole.

Suitable polyurethanes are derived from a polyol and a polyisocyanate. Examples of useful polyols include polyester polyols, polyether polyols, and combinations thereof. Useful polyester polyols include, e.g., crystalline polyester polyols and amorphous polyester polyols.

Suitable polyester polyols include, e.g., polyester polyols derived from linear dicarboxylic acids, derivatives of dicarboxylic acids including cyclic dicarboxylic acids e.g., anhydrides, esters and acid chlorides), aliphatic polyols, cyclo aliphatic polyols, polyols, branched polyols, and combinations thereof. Examples of useful dicarboxylic acids from which the polyester polyol can be derived include adipic acid, succinic acid, sebacic acid, dodecanedioic diacid, and combinations thereof. Examples of useful aliphatic diols from which the polyester polyol can be derived include ethylene glycol, 1,3-propanediol, 1,4-butanediol, 1,5-pentanediol, 1,5-pentanediol, 1,6-hexanediol, neopentyl glycol, and combinations thereof. Useful polyester polyols include, e.g., polyester polyols derived from 1,4-butanediol, 1,6-hexanediol, and combinations thereof including, e.g., polyester polyols derived from adipic acid and 1,4-butanediol, adipic acid and 1,6-hexanediol, adipic acid, 1,6-hexanediol, and neopentyl glycol, and combinations thereof.

Suitable polyether polyols include the products obtained from the polymerization of a cyclic oxide, e.g., ethylene oxide, propylene oxide, butylene oxide, and tetrahydrofuran, or by the addition of one or more such oxides to polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol and bisphenol A), ethylenediamine, propylenediamine, triethanolamine, and 1,2-propanedithiol. Particularly useful polyether polyols include, e.g., polyoxypropylene diols and triols, poly(oxyethylene-oxypropylene) diols and triols obtained by the simultaneous or sequential addition of ethylene oxide and propylene oxide to appropriate initiators and polytetramethylene ether glycols obtained by the polymerization of tetrahydrofuran.

Useful polyisocyanates have at least two free isocyanate groups in each molecule and include, diiosocyantes, triisocyanates, higher order polyisocyanates, and combinations thereof. Examples of useful polyisocyanates include e.g., aliphatic isocyanates (e.g. hexamethylene diisocyanate (HDI)), tetramethylxylylene diisocyanate (TMXDI)), cycloaliphatic isocyanates (e.g., 1-isocyanto-3,3,5-trimethyl-5-isocyanatomethyl-cyclohexane (IPDI), hydrogenated methylene diphenyl diisocyanate (H₁₂MDI)), heterocyclic isocyanates, and aromatic isocyanates (e.g. methylene diphenyl diisocyanate (MDI), toluene diisocyanate (TDI)), napthalene-1,5-diisocyanate (NDI), 3,3′-dimethyl-biphenyl-4,4′-diisocyanate (TODI), dimeric MDI, the uretdione of MDI (MDIU), the uretdione of TDI (TDIU), 3,3′-diisocyanate-4,4′-dimethyl-N,N′-diphenyl urea (TDIH), addition product of 2 moles of 1-methyl-2,4-phenylene-diisocyanate with 1 mole of 1,2-ethandiol or 1,4-butandiol; addition product of 2 moles of MDI to 1 mole of diethylene glycol; and the combinations thereof.

The polyurethane can be in the form of an aqueous polyurethane dispersions, preferably anionic polyurethane dispersions. Examples of useful commercially available polyurethane dispersions include DISPERCOLL U53, DISPERCOLL U56, DISPERCOLL U XP 2682, DISPERCOLL U 8755, DISPERCOLL U 2824 XP, DISPERCOLL U 2815 XP, DISPERCOLL U54, DISPERCOLL U XP 2710, DISPERCOLL U 2849 XP, DISPERCOLL U42 AND DISPERCOLL U XP 2643, all of which are available from Bayer Material Science AG (Germany); WD4047, which is available from HB Fuller Company (St. Paul, Minn.); and LUPHEN 585, LUPHEN 3615, LUPHEN D 207 E and LUPHEN D DS 3548, all of which are available from BASF.

The aqueous composition (preferably includes at least 15% by weight, at least 25% by weight, from about 15% by weight to about 60% by weight, from about 25% by weight to about 60% by weight, from about 40% by weight to about 60% by weight, or even from about 40% by weight to about 50% by weight polyurethane, based on the weight of the aqueous composition.

Surface Deactivated Solid Isocyanate

The first heat curable adhesive portion of the film preferably includes at least 1% by weight, at least 2% by weight, at least 4% by weight, from about 4% by weight to about 25% by weight, from about 4% by weight to about 20% by weight, or even from about 4% by weight to about 10% by weight surface-deactivated solid isocyanate, based on the weight of the dried heat curable adhesive film.

The surface-deactivated solid isocyanate is in the form of a solid particulate and functions as a crosslinking agent. Useful surface-deactivated solid isocyanate can be derived from a polyisocyanate and a deactiving agent.

A variety of polyisocyanates are suitable including, e.g., aliphatic, cycloaliphatic, heterocyclic, and aromatic isocyanates. Specific examples of useful polyisocyanates include dimeric 4,4′-MDI, the uretdione of MDI (MDIU), the uretdione of TDI (TDIU), 3,3′-diisocyanate-4,4′-dimethyl-N,N′-diphenyl urea (TDIH), the addition product of 2 moles of 1-methyl-2,4-phenylene-diisocyanate and 1 mole of 1,2-ethandiol or 1,4-butandiol, the addition product of 2 moles of MDI and 1 mole of diethylene glycol, the isocyanurate of isophoron diisocyanate (IPDI-T), and combinations thereof.

Commercially available solid isocyanates that can be surface-deactivated include the uretdione of TDI (e.g., ADOLINK TT available from Rhein Chemie Rheinau (GmBH (Mannheim, Germany), DANCURE 999 available from Danquinsa GmBH (Germany), THANECURE T9 (TSE, Clearwater, Fla.)); DESMODUR LP BUEJ 471, which is a micronized IPDI-isocyanurate available from Bayer Material Science AG (Germany); uretdione of MDI (GRILBOND A2BOND available from EMS-Griltech (Switzerland)) and ISOQURE TT available from Kautschuk-Gesellschaft (Frankfurt, Germany).

The surface-deactivated solid isocyanate preferably is deactivated by the presence of a deactivating agent. Useful deactivating agents include, e.g., primary aliphatic amines, secondary aliphatic amines, diamines, polyamines, hydrazine derivatives, amidines, guanidines, and combinations thereof. Examples of useful deactivating agents include ethylene diamine, 1,3-propylene-diamine, diethylene triamine, triethylene tetramine, 2,5-dimethyl-piperazine, 3,3′-dimethyl-4,4′-diamino-dicyloheyl methane, methyl nonane-diamine, isophoron diamine, 4,4′-diaminodicyclohexyl methane, diamino polypropylene ether, triamino polypropylene ether, polyamido amine, the deactivating agents disclosed in U.S. Pat. No. 6,348,548 B1, and combinations thereof.

The surface-deactivated solid isocyanates can be prepared according to a variety of methods including, e.g., the processes described in U.S. Pat. No. 6,348,548 B1, which is incorporated herein by its entirety.

The surface-deactivated solid isocyanate can be in a variety of forms including, e.g., aqueous suspensions, micronized particles, and combinations thereof.

Useful commercially available surface-deactivated solid isocyanates include, e.g., DISPERCOLL BL XP 2514 (an aqueous suspension of surface-deactivated isocyanate containing approximately 40% of the uretdione of TDI) available from Bayer Material Science AG (Germany)) and AQUALINK U from Aquaspersions Limited (UK).

The surface-deactivated solid isocyanate can be blended with the polyurethane dispersion to form a stable aqueous composition.

The aqueous composition preferably includes at least 0.25% by weight, at least 0.5% by weight, at least 1% by weight, from about 0.25% by weight to about 10% by weight, from about 0.5% by weight to about 8% by weight, or even from about 1% by weight to about 5% by weight surface-deactivated isocyanate, based on the weight of the aqueous composition.

Additional Components

The first heat curable adhesive composition and the aqueous composition optionally include a variety of other additives including, e.g., other polymers, catalysts (e.g. amine based), preservatives, pH modifiers (e.g. aqueous ammonia), adhesion promoters (e.g. tackifiers, silane containing compounds), color agents, surfactants, defoaming agents, fungicides, bactericides, thickening agents, blocking agents and stabilizers (e.g. amines), fillers (e.g. carbonates, talc, starch), materials that help the adhesive film to form a barrier (e.g. nano clay), insulative materials (e.g. mineral fillers, glass microbubbles), electric conductive materials (e.g. various metals (e.g. silver)), and combinations thereof.

A second polymer can be present. Second polymers that can be present in the aqueous composition include, e.g., polyurethanes that are not reactive with isocyanate functionality; vinyl acetate ethylene copolymers (VAE); polyvinyl alcohol (PVOH); polyvinyl acetate (PVAc); polyacrylates that are not reactive with isocyanate functionality; acrylonitriles (e.g., butadiene acrylonitrile); styrene butadiene rubber (SBR); and combinations thereof.

When a second polymer is present in the first heat curable adhesive composition, the sum of the polyurethane reactive with isocyanate functionality, the surface-deactivated solid isocyanate, and the second polymer amounts to at least 90% by weight, at least 95% by weight, or even at least 98% of the weight of the dried, heat curable adhesive.

One example of a useful stabilizer is JEFFAMINE T-403 POLYETHERAMINE commercially available from Huntsman Corporation (The Woodlands, Tex.).

Useful thickeners include, e.g., BORCHI® GEL A LA available from OMG Borchers GmbH (Langenfeld, Germany) and STEROCOLL HT commercially available from BASF Chemical Company (Ludwigshafen, Germany),

On example of a useful preservative is ACTICIDE MBS commercially available from Thor GmbH (Speyer, Germany).

### Second Adhesive Composition

The second adhesive composition can be any adhesive composition different from the first heat curable adhesive composition.

The second adhesive composition can be selected from the group consisting of a tacky adhesive composition, a second heat curable adhesive composition, a two part epoxy, a UV curable adhesive, a two part room temperature curable urethane, a moisture cure adhesive, a hot melt adhesive, water based adhesive and solvent based adhesive.

The second adhesive composition can be a tacky adhesive composition. Tacky adhesive composition refers to an adhesive composition that has tack at room temperature (i.e., from about 22° C. to about 25° C.).

Classes of suitable tacky adhesive compositions include, e.g., water-based, solvent-based, solvent-free, hot melt, reactive (e.g., moisture curable, radiation curable), and combinations thereof. Examples of suitable tacky adhesive compositions in terms of the base polymer contained in the adhesives include e.g., rubber-based, polyacrylate-based, vinyl alkyl ether-based, polyvinylchloride based, polyurethane-based, block copolymer based, and the like. Such tacky adhesives can be used alone or in combination of two or more.

Examples of useful commercially available tacky adhesive compositions include water based acrylate-based dispersions e.g., PD2056F, PD2656 and ACRYLTAC SP405, water based polyurethane dispersions e.g., WD 4051 and WD 4007, and moisture curable polyurethane e.g., NP6231, all of which are available from H.B. Fuller Company (St. Paul, Minn. (MN)); ACRONAL pressure-sensitive adhesives including e.g., ACRONAL N-CR3010 (acrylic polymers available from BASF, Florham Park, N.J.); ROBOND pressure-sensitive adhesives including e.g., ROBOND PS 7165 and ROBOND PS-9908 (The Dow Chemical Company, Midland, Mich.); NACOR pressure-sensitive adhesives (e.g., emulsion compositions based on acrylic monomers and vinyl acetate) (Henkel Corporation, Düsseldorf, Germany); and AROSET emulsion pressure-sensitive adhesives (Ashland Inc., Covington, Ky.).

The second adhesive composition can alternatively be a second heat curable adhesive different from the first.

The second adhesive composition is different from the first heat curable adhesive composition. This difference can be used to introduce different properties into the adhesive film. The second adhesive could be different from the first heat curable adhesive in terms of activation temperature, breathability, water permeability, adhesion, thermochromic properties, stiffness, flexibility, viscosity, flow properties, color or any other property.

### Methods of Making

A variety of methods can be used to prepare the adhesive film.

In one method, the embedded adhesive is coated in discrete domains onto a release liner. The discrete domains can be in any form including e.g. random, splatter, dots, stripes, spirals, dashes, irregular shapes, islands, frames and combinations thereof.

The embedded adhesive can be applied to the release liner using any suitable method including, e.g., spraying, roll-to-roll, slot coating, gravure coating, flexographic coating, screen printing and combinations thereof.

The primary adhesive is then coated in a continuous film over the top of the embedded adhesive. The release liner facing side comprises the first major surface of the adhesive film. The outward facing surface of the primary adhesive comprises the second major surface of the adhesive film.

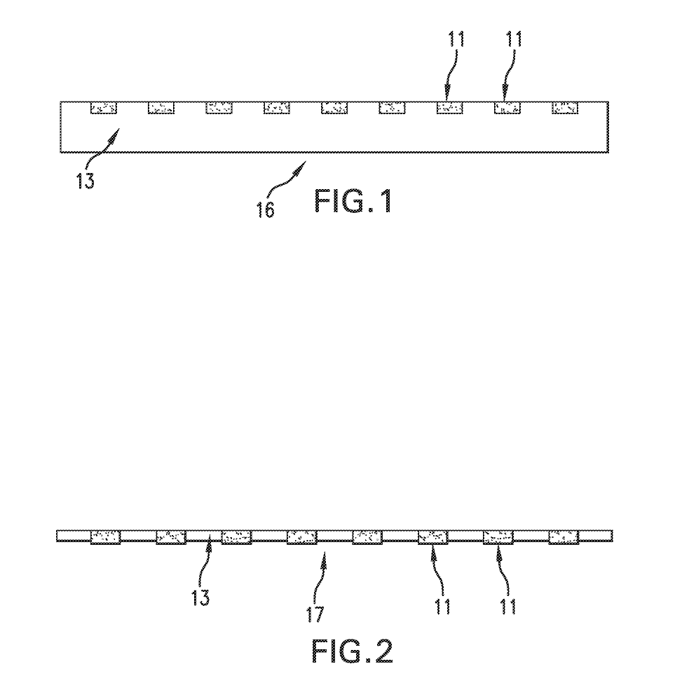

If the primary adhesive is coated at a thickness greater than the height of the discontinuous pattern, the embedded adhesive will only be exposed on the first major surface of the adhesive film (FIG. 1). Alternately, if the primary adhesive is coated at a thickness less than the height of the discontinuous pattern, the embedded adhesive will be exposed on the first major surface and the second major surface of the adhesive film (FIG. 2).

In another embodiment, a film with embedded adhesive exposed on both major surfaces can be obtained by mating together two films with embedded adhesive exposed on one major surface.

The primary adhesive can be applied using a variety of application techniques including, e.g., spraying (e.g. spiral and splatter spraying), coating (e.g. roll, slot, gravure, and pattern), and combinations thereof.

If the primary adhesive is aqueous, one useful application method includes roll coating the aqueous composition at a desirable coat weight, directly on top of the embedded adhesive and over the release liner, and then passing the adhesive film through a drying tunnel to form the dried, adhesive film. The drying temperature in the tunnel can be any suitable temperature or series of temperatures.

If the primary adhesive is a first heat curable adhesive, the drying tunnel temperature is preferably is maintained at a temperature that is sufficiently low to prevent the surface-deactivated solid isocyanate from activating crosslinking). During drying the tunnel temperature is preferably maintained at a temperature of no greater than about 70° C., no greater than about 60° C., or even no greater than about 55° C. The heat curable adhesive film optionally can be chilled (e.g. by passing the film over a chilled roller). The heat curable adhesive film disposed on the release liner can be wound as a roll, and stored for a later date to be used.

### Uses

The adhesive film is useful in a variety of applications including, e.g., temporarily bonding at least one substrate, permanently bonding at least one substrate, protecting a substrate, inhibiting or preventing the movement of a first substrate relative to a second substrate, and combinations thereof. The adhesive film is also useful in a variety of processes including, e.g., manufacturing processes (e.g., bonding two or more parts of an article together and maintaining two parts in fixed relation to one another during the manufacturing process), shipping processes, stacking processes, and combinations thereof.

The adhesive film can be used in the manufacture of a variety of articles including, e.g., shoes, automobile parts, truck bed covers, textile laminations (e.g. outdoor apparel, lingerie, upholstery), various assembled goods (e.g., panels, laminations, filters, flooring, etc.), and electronics (e.g., metallic parts, plastic parts, glass, glass fiber reinforced plastics).

In one embodiment as illustrated by FIG. 1, a one layer adhesive film (16) includes discrete domains of a partially embedded adhesive composition (11) in the form of dots exposed on the first major surface of a primary adhesive (13).

In another embodiment as illustrated by FIG. 2, a one layer two-sided adhesive film (17) includes discrete domains of a partially embedded adhesive composition (11) in the form of dots exposed on the first major surface and the second major surface of the primary adhesive (13).

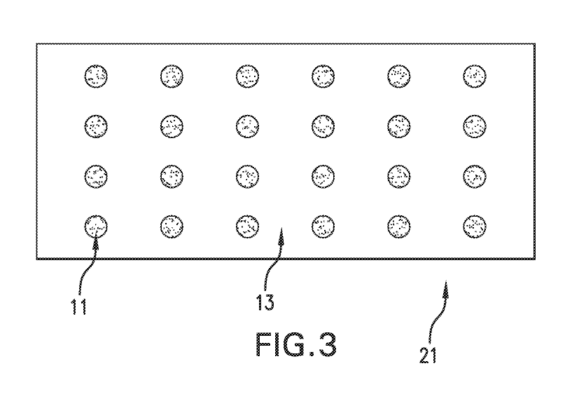

FIG. 3 is a top view of the first major surface of a one layer adhesive film (21) with the partially embedded adhesive (11) present as a pattern of dots within the primary adhesive (13).

The adhesive film can be used to bond two substrates together.

The first and the second substrates can be of the same or different material. In one embodiment, the first substrate is flexible and the second substrate is rigid. In another embodiment, the first substrate is rigid and the second substrate is flexible. In other embodiments, the first substrate is flexible and the second substrate is flexible. Alternatively, both substrates are rigid.

Useful substrates include rigid substrates and flexible substrates. Examples of suitable rigid substrates include tiles, ceramics, metals (e.g. aluminum, stainless steel), synthetic polymer (e.g., polyamide (e.g. nylon), polyethersulfones, polyphenylenesulfones, etc.), regenerated cellulose (e.g. viscose, rayon, cellulose acetates), polyester, polystyrene, acrylate, polyolefin (e.g., polypropylene, polyethylene, and combinations thereof), ethylene vinyl acetate, polyvinyl chloride, polyurethane, polycarbonate, acrylonitrile-butadiene-styrene, blends of acrylonitrile-butadiene-styrene and polycarbonate, polyether ether ketone, and combinations thereof), composites (e.g. fiber reinforced polymers), glass, cardboard, wood and wood-containing products (e.g., wood composites, composites that include wood pulp and polymer), and combinations thereof. The rigid substrate can be in the form of a single layer or multiple layers.

Useful flexible substrates include, e.g., woven and nonwoven fabrics (e.g., microfiber, canvas), leather, artificial leather, furs, fabrics, films, foils (e.g. decorated foils), papers, and combinations thereof. Flexible substrates can be prepared from a variety of materials including, e.g., cellulose-based materials (e.g., regenerated cellulose, wood pulp, cotton, rayon and viscose), synthetic polymers nylon, polyesters, acrylate, polyolefin (e.g., polypropylene, polyethylene, polystyrene, and combinations thereof), ethylene vinyl acetate, polyvinyl chloride, polyurethane, and combinations thereof), and combinations thereof.

The substrate can be pre-treated to improve adhesion of the adhesive film to the substrate. Useful pre-treatments include, e.g., corona, plasma, flame, chemical primer, and combinations thereof.

### Methods of Making and Using

The adhesive film can be adhered to a first substrate either through the embedded adhesive composition or through the heat curable adhesive film.

In one embodiment the embedded adhesive composition is a tacky adhesive composition and the primary adhesive composition is a heat curable adhesive. The first substrate is contacted with the tacky adhesive composition of the adhesive film so as to affix the first substrate to the adhesive film. The tacky adhesive composition assists in maintaining the first substrate in a fixed position relative to the adhesive film. Alternatively, prior to heating the adhesive film, a second substrate is placed in direct contact with the second major surface of the adhesive film, then the adhesive film is heated to a temperature that is sufficient to activate the surface-deactivated solid isocyanate within the heat curable adhesive of the adhesive film.

Alternately, if the adhesive film has exposed adhesive on both major surfaces, the tacky adhesive composition can be used to fix a first and a second substrate in place. The adhesive film can then be heated to a temperature that is sufficient to activate the surface-deactivated solid isocyanate within the heat curable adhesive of the adhesive film.

In another embodiment, a first substrate is brought into direct contact with the second major surface of the multiple adhesive film, and a release liner is in direct contact with the first tacky adhesive of the adhesive film. The adhesive film can then be heated to a temperature that is sufficient to activate the surface-deactivated solid isocyanate within the heat curable adhesive of the adhesive film.

Alternatively, the adhesive film can be heated to a first temperature that is sufficient to render the heat curable adhesive film tacky such that the first substrate can be maintained in a fixed position relative to the adhesive film to form a laminate. Upon cooling to the room temperature, the laminate (if flexible) can be wound as a roll and stored to a later date to be further heat-activated to cure (i.e. crosslink),

Alternatively, a second substrate can be brought into contact with the tacky adhesive of the adhesive film, and the temperature can be increased to a second temperature that is sufficient to activate the surface-deactivated solid isocyanate to bond the two substrates together through the adhesive film.

In another embodiment, an article is prepared by contacting a first substrate with the tacky adhesive composition of the adhesive film, heating the adhesive film to a first temperature sufficient to render the heat curable adhesive film of the adhesive film tacky, then contacting the tacky surface of the heat curable adhesive film with a second substrate to form a heat curable laminated article. The heat curable laminated article is storage stable such that it can be placed in a storage to a later date, then undergoes a curing process at an end user's facility.

Alternatively, the heat curable laminated article can be heated to a second temperature sufficient to activate the surface-deactivated solid isocyanate and begin the curing of the heat curable adhesive film.

Preferably the bond formed between the adhesive film and the first substrate (and the second substrate, where present) is a destructive bond (i.e., either the substrate or the multi-layer adhesive film (or both) is damaged when an attempt is made to peel the substrate away from the adhesive film.

The invention will now be described by way of the following examples. All ratios and percentages are by weight unless otherwise indicated.

### EXAMPLES

### Test Procedures

Test procedures used in the examples and throughout the specification, unless stated otherwise, include the following.

### Molecular Weight

The gel permeation chromatography (GPC) molecular weight distribution curve of each polyurethane sample is obtained using a Waters 2695 Separations Module connected to a Waters 2414 Refractive Index (RI) detector, running 0.05 molar (M) lithium bromide dimethyl formamide (LiBr/DMF) mobile phase through two Agilent Resipore GPC columns. The weight average molecular weight (Mw) data is calculated versus polymethyl methacrylate standards.

### Peak Melting Temperature and Enthalpy of Fusion Test Method

The peak melting temperature and enthalpy of fusion (ΔH) of the dried polyurethane dispersions is determined, after removal of the heat history, using a Perkin Elmer, Pyris 1 Differential Scanning calorimetry (DSC), at a heating rate of 10° C. per minute.

### Loop Tack Test Method

Loop tack is determined, using an Instron tester model 5500R (Instron Corporation, Norwood, Mass.), according to the ASTM D 6195-03 test method entitled “Standard Test Methods for Loop Tack” to measure the force to separate the adhesive from a 316 stainless steel plate (i.e., debonding strength) in grams force (gf). The method involves the use of loops prepared from 5 in (127 mm) specimen strips. The maximum bonding load results are reported in gram-force per 25 millimeters (gf/25 mm).

Samples for use in the Loop Tack test method are prepared by cutting a piece of an adhesive film into 1 in×5 in (25.4 mm×127 mm) specimen strips in the machine direction. The strips are then conditioned at 23° C. +/−1° C. and a relative humidity of 50% +/−2% for 24 hours.

### Cured 180 Degree Peel Strength Test Method

The cured 180 degree (180°) peel strength is determined, using an Instron tester model 5500R (Instron Corporation, Norwood, Mass.), according to the ASTM D903-98 test method entitled “Standard test method for Peel or Stripping Strength of Adhesive Bonds”, with the following exceptions:
1. Test Speed/Rate of travel of the power-actuated grip: A speed of 300 mm/min is used for sample testing instead of 305 mm/min.
2. Length of test substrates and bond:
   8 inch (in) (203.2 mm) flexible substrates are used for testing instead of 12 in (304.8 mm) flexible substrates
   4 in (101.6 mm) rigid substrates are used for testing instead of 8 in (203.2 mm) rigid substrates
   A bond length of 3.5 in (88.9 mm) inches is used for testing instead of a bond length of 6 in (152.4 mm); and
3. Samples are conditioned 23° C. +/−1° C. and 50% +/−2% relative humidity for 24 hours.

The mean of the average peel strength for a set of six samples is reported.

### Cured 180 Degree Peel Strength Test Method Sample Preparation Method

For a one layer heat curable adhesive film that includes a tacky adhesive composition that is at least partially embedded within the heat curable adhesive, a 1 in×4 in×0.125 in (25.4 mm×101.6 mm×3.2 mm) piece of rigid polycarbonate (PC) substrate (General Purpose grade Makrolon, from Bayer) is cleaned with isopropyl alcohol (IPA) and dried. A 1 in×3.5 in (25.4 mm×88.9 mm) piece of the one layer heat curable adhesive film with an at least partially embedded tacky adhesive composition is then placed onto the IPA-cleaned PC substrate such that the at least partially embedded tacky composition is in contact with PC substrate. A flexible nylon substrate is then placed on top of the PC substrate/heat curable adhesive film composite. The PC/heat curable adhesive film with an at least partially embedded tacky adhesive/nylon fabric layered construction is then bonded together using a heated platen press at a temperature sufficient to activate curing of the heat curable reactive film.

To test the heat curable adhesives films that includes a tacky adhesive composition that is at least partially embedded within the heat curable adhesive of the examples set forth below, the heated platen press is set to the following conditions:

Bondline temperature: 90 ° C.

Time at bondline temperature: 60 s

Pressure: 22 N/cm2

### EXAMPLES

The following heat curable adhesive and tacky adhesive compositions, all of which are commercially available from HB Fuller Company (St. Paul, Minn.) could be used to form one layer multiple adhesive films.
Various aqueous heat curable polyurethane-based adhesives including surface-deactivated solid isocyanate, are commercially available from HB Fuller Company under the THERMONEX trade designation.
WD4007 is a water-based polyurethane dispersion that is derived from polyether polyol and isophorone isocyanate and that forms a tacky adhesive when dry.
WD4051 is a water-based polyurethane dispersion that is derived from polyether poly and isophorone isocyanate and that forms a tacky adhesive when dry.
ACRYLTAC SP405 is a water-based acrylic copolymer dispersion that forms a tacky adhesive when dry.
NP 6231 is a moisture curable polyurethane that forms a tacky adhesive when cured.

Samples of Control 1, Control 2, Examples 1 and 2 according to Table 1 were prepared according to the herein described Cured 180 Degree Peel Strength Test Method Sample Preparation Method, then stored at 23° C. +/−1° C. and 50% +/−2% relative humidity for approximately 24 hours before being tested according to the Cured 180 Degree Peel Strength Test Method.

TABLE 1

| | Tacky | Tacky Adhesive | Cured 180 | |
|---|---|---|---|---|
| | Adhesive | Coat weight | Peel Strength | Standard |
| Sample | Type | (g/m²) | (N/25 mm) | Deviation |
| Control 1 | None | 0 | 32.71 | 0.50 |
| Example 1 | Adhesive 2141 | 10 | 34.69 | 4.21 |
| Control 2 | None | 0 | 65.04 | 1.40 |
| Example 2 | Adhesive 2141 | 10 | 57.08 | 5.56 |

Control 1: EM9002-25 (25 micron thickness), commercially available from H B Fuller Company
Control 2: EM9002-50 (50 micron thickness), commercially available from H B Fuller Company
Adhesive 2141 is a dried form of an aqueous dispersion formed from 2-thylhexylacrylate, ethylacrylate and acrylonitrile, which has a Tg of about −44° C.
Example 1: 25 micron thick heat curable adhesive film where tacky Adhesive 2141 is at least partially embedded in EM9002
Example 2: 50 micron thick heat curable adhesive film where tacky Adhesive 2141 is at least partially embedded in EM9002

Other embodiments are within the claims. All publications cited herein are incorporated herein in their entirety.

We claim:

1. An adhesive film comprising:
a first heat curable adhesive composition; and
a second adhesive composition different from the first,
the adhesive film being one layer, and one of the first or second adhesive compositions being partially embedded within the other;
the first heat curable adhesive comprising:
a surface-deactivated solid isocyanate; and
a polymer reactive with isocyanate functionality.

2. The adhesive film of claim 1 wherein the partially embedded adhesive composition is present in discrete domains.

3. The adhesive film of claim 2 wherein the discrete domains are in the form of dots.

4. The adhesive film of claim 1 wherein the polymer reactive with isocyanate functionality is a polyurethane.

5. The adhesive film of claim 1 wherein the second adhesive composition is a tacky adhesive composition.

6. The adhesive film of claim 1 wherein the second adhesive composition is a second heat curable adhesive composition.

7. The adhesive film of claim 4 wherein the first heat curable adhesive comprises at least about 60% by weight of a polyurethane, based on the weight of the heat curable adhesive.

8. The adhesive film of claim 4, wherein the polyurethane has a weight average molecular weight of no greater than about 100,000 g/mole.

9. The adhesive film of claim 4, wherein the polyurethane has an enthalpy of fusion of at least about 25 J/g.

10. The adhesive film of claim 5, wherein the tacky adhesive composition comprises polyurethane, polyacrylate, or a combination thereof.

11. The adhesive film of claim 1, wherein the adhesive film is supplied on release liner.

12. The adhesive film of claim 1, wherein the adhesive film has a thickness of from about 10 microns to about 200 microns.

13. The adhesive film of claim 1, wherein the heat curable adhesive is derived from an aqueous composition comprising
a surface-deactivated solid isocyanate derived from an aromatic isocyanate, an aliphatic isocyanate, or a combination thereof, and a polyurethane having an enthalpy of fusion of at least about 25 J/g.

14. The adhesive film of claim 4, wherein the polyurethane is derived from a crystalline polyester polyol and an isocyanate.

15. The adhesive film of claim 13, wherein the composition further comprises a second polymer.

16. A adhesive film made by a process comprising the following steps:
coating a second adhesive composition in discrete domains onto a release liner, and;
coating a first heat curable adhesive directly over the second adhesive composition to form an adhesive film that is one layer;
the second adhesive composition and the first heat curable adhesive composition being different from each other and the first heat curable adhesive composition comprising a surface-deactivated solid isocyanate and a polymer reactive with isocyanate functionality.

17. The adhesive film of claim 16 wherein the polymer reactive with isocyanate functionality is a polyurethane.

18. The adhesive film of claim 16 wherein the second adhesive composition is a tacky adhesive composition.

19. The adhesive film of claim 16, wherein the second adhesive is exposed on one major surface of the adhesive film.

20. The adhesive film of claim 16, wherein the second adhesive is exposed on both major surfaces of the adhesive film.

21. A method of making an article having a first substrate and a second substrate, the method comprising:
contacting the first substrate with the tacky adhesive composition of the adhesive film of claim 5;
heating the adhesive film to a first temperature sufficient to render the first heat curable adhesive of the adhesive film tacky; and
contacting a second substrate with the first heat curable adhesive of the adhesive film.

22. The method of claim 21 additionally comprising heating the article to a second temperature so as to cure the first heat curable adhesive.

23. A method of making an article having a first substrate and a second substrate, the method comprising:
contacting the first substrate with the tacky adhesive composition of the adhesive film of claim 5;
contacting a second substrate with the first heat curable adhesive of the adhesive film; and
applying pressure and heat to the assembly to form a permanent adhesive bond between the substrates.

24. The method of claim 21, wherein the first temperature is at least about 30° C.

25. The method of claim 21, wherein one of the first substrate and the second substrate is rigid and the other of the first substrate and the second substrate is flexible.

26. The method of claim 25, wherein the rigid substrate is selected from the group consisting of metal, metal composite, plastic, plastic composite, wood, wood-composite, glass and combinations thereof.

27. The method of claim 25, wherein the flexible substrate is selected from the group consisting of fabric, film, foil, paper, regenerated cellulose and combination thereof.
